(19) United States
(12) Patent Application Publication
(10) Pub. No.: US 2026/0010654 A1
(43) Pub. Date: Jan. 8, 2026

(54) USER DATA EXCHANGE SYSTEM

(71) Applicant: TOYOTA JIDOSHA KABUSHIKI KAISHA, Toyota-shi (JP)

(72) Inventors: Sho NAKATANI, Tokyo (JP); Kenichi Murata, Tokyo (JP)

(73) Assignee: TOYOTA JIDOSHA KABUSHIKI KAISHA, Toyota-shi (JP)

(21) Appl. No.: 19/250,478

(22) Filed: Jun. 26, 2025

(30) Foreign Application Priority Data
Jul. 2, 2024 (JP) 2024-107027

(51) Int. Cl. G06F 21/62

(52) U.S. Cl. CPC G06F 21/6263

(57) ABSTRACT

The information processing apparatus transmits a first identifier in response to a request for issuance of a user identifier sent from a DC, transmits a second identifier in response to a request for issuance of the user identifier sent from a DP, receives, from the DC, a ticket issuance request comprising information identifying user data requested by the DC, the first identifier, and DP as the request destination, issues a data request ticket corresponding to the ticket issuance request, transmits a ticket identifier of the issued data request ticket to the DC, and when ticket identifier is received from the DP, transmits the data request ticket corresponding to the ticket identifier to the DP. The ticket issuing request includes a first identifier, and the data request ticket transmitted to the DP includes a second identifier corresponding to the first identifier.

### CROSS REFERENCE TO RELATED APPLICATION

This application claims the benefit of Japanese Patent Application No. 2024-107027, filed on Jul. 2, 2024, which is hereby incorporated by reference herein in its entirety.

### BACKGROUND

### Technical Field

The present disclosure relates to a user data exchange system.

### Description of the Related Art

Patent Document 1 discloses an e-commerce system capable of buying and selling goods without communicating personal information from the purchaser to the seller. Specifically, when the proxy server acts as a proxy for access to the product information provision server by the client, it sends the user ID to the product information provision server. The product information providing server transmits the product ID and the user ID to the proxy server, when the product purchase command is received. The proxy server then derives the delivery destination information based on the user ID, and transmits the product ID and the delivery destination information to the delivery management server.

### CITATION LIST

### Patent Document

[Patent Document 1] Japanese Patent Laid-Open No. 2003-233729

One aspect of the present disclosure is to provide a technology that can more securely enable the exchange of personal information between a data provider and a data consumer.

### SUMMARY

One aspect of the present disclosure is a user data exchange system comprising a data consumer, a data provider, and a platformer, and intermediating exchange of user data between the data consumer and the data provider, wherein
the data consumer transmits a first identifier issuance request to the platformer to request issuance of a user identifier,
the platformer, in response to receiving the first identifier issuance request, generates a first identifier, transmits the first identifier to the data consumer, and stores the first identifier in association with a third identifier for identifying the user,
the data consumer stores the first identifier in association with a first user ID,
the data provider transmits a second identifier issuance request to the platformer to request issuance of a user identifier,
the platformer, in response to receiving the second identifier issuance request, generates a second identifier, transmits the second identifier to the data provider, and stores the second identifier in association with the third identifier,
the data provider stores the second identifier in association with a second user ID,
the data consumer transmits, to the platformer, a ticket issuance request including information identifying user data to be requested, the first identifier corresponding to the first user ID, and information identifying the data provider as a destination of a request for the user data,
the platformer, in response to receiving the ticket issuance request, generates a data request ticket including a ticket identifier, the third identifier corresponding to the first identifier, the information identifying the user data, and the information identifying the data provider as the destination of a request for the user data, and transmits the ticket identifier to the data consumer,
the data consumer transmits a data acquisition request including the ticket identifier to the data provider,
the data provider transmits a ticket reference request including the ticket identifier included in the data acquisition request to the platformer,
the platformer identifies the data request ticket corresponding to the ticket identifier included in the ticket reference request, and transmits the information identifying the user data and the second identifier corresponding to the third identifier to the data provider,
the data provider transmits the user data to be requested and relating to a user identified by the second user ID corresponding to the second identifier to the data consumer, and
at least one of the data consumer or the data provider uses, as the first user ID or the second user ID, an identifier issued after the user has been authenticated by an ID provider, without retaining account information of the user.

One aspect of the present disclosure is a user data exchange system comprising a data consumer, a data provider, a platformer, a first ID provider, and a second ID provider, and intermediating the exchange of user data between the data consumer and the data provider, wherein
the first ID provider stores a first user ID of the user,
the second ID provider stores a second user ID of the user,
the data consumer transmits a first identifier issuance request to request issuance of a user identifier to the platformer via the first ID provider,
the platformer, in response to receiving the first identifier issuance request, generates a first identifier, transmits the first identifier to the first ID provider, and stores the first identifier in association with a third identifier identifying the user,
the first ID provider stores the first identifier in association with the first user ID,
the data provider transmits a second identifier issuance request to request issuance of a user identifier to the platformer via the second ID provider,
the platformer, in response to receiving the second identifier issuance request, generates a second identifier, transmits the second identifier to the second ID provider, and stores the second identifier in association with the third identifier,
the second ID provider stores the second identifier in association with the second user ID,
the data consumer transmits, to the first ID provider, a first ticket issuance request including information identifying user data to be requested and information identifying the data provider as a destination of a request for the data user,
the first ID provider, in response to receiving the first ticket issuance request, transmits a second ticket issuance request including the information identifying the user data to be requested, the first identifier, and the information identifying the data provider as the destination of the request of the user data to the platformer,
the platformer, in response to receiving the second ticket issuance request, generates a data request ticket including a ticket identifier, the third identifier corresponding to the first identifier, the information identifying the user data, and the information identifying the data provider as the destination, and transmits the ticket identifier to the data consumer via the first ID provider,
the data consumer transmits a data acquisition request including the ticket identifier to the data provider,
the data provider transmits a ticket reference request including the ticket identifier included in the data acquisition request to the platformer via the second ID provider or directly,
the platformer, in response to receiving the ticket reference request, identifies the data request ticket corresponding to the ticket identifier included in the ticket reference request, and transmits the information identifying the user data and the second identifier corresponding to the third identifier to the data provider via the second ID provider or directly,
the data provider transmits the user data to be requested and related to the user identified by the second user ID corresponding to the second identifier to the data consumer.

According to aspects of the present disclosure, it is possible to securely exchange personal information between a data provider and a data consumer.

### BRIEF DESCRIPTION OF DRAWINGS

FIG. 1 is a diagram illustrating an overview configuration of the data exchange system according to one embodiment;

FIGS. 2A to 2D are diagrams illustrating an example of an ID correspondence table held by each device according to one embodiment;

FIG. 3 is a sequence diagram illustrating the data exchange process according to a first embodiment;

FIG. 4 is a sequence diagram illustrating a dummy ID issuance process according to the first embodiment;

FIG. 5 is a sequence diagram illustrating a dummy ID issuance process according to a second embodiment; and

FIG. 6 is a sequence diagram illustrating a data exchange process according to the second embodiment.

### DESCRIPTION OF THE EMBODIMENTS

The value of data has become widely known, and many services are accumulating user data. It is widely practiced to provide the data API as a data provider for the user data holder to provide the user data to the data consumer.

In such a data exchange system, charging arbitration and the prevention of aggregation of names are issues. In this embodiment, the platformer mediates the exchange of data between the data provider and the data consumer, and solves the above problems by a novel mediation method.

In the present disclosure, platformer, data provider, and data consumer are all terms that refer to an apparatus and not a business operator or an individual. In addition, in the present disclosure, the platformer is sometimes referred to as PF, the data provider is referred to as DP, and the data consumer is referred to as DC.

Some DPs and DCs rely on an ID provider (IdP) to manage account information and authenticate the user, without the service provider owning the user's account information. For example, there is a service that lets you select a Google account when you try to log in to the service. Services relying on IdP are called Relying Party (RP) in the OpenID Connect standard and Service Provider in the SAML standard. Although no restriction to a specific standard is intended in the following, services relying on IdP are referred to as RP.

The present disclosure proposes a method of mediating the exchange of data between DPs and DCs, when DP or DC is RP.

Some embodiments of the present disclosure will be described below on the basis of the drawings. The following configuration of embodiments is exemplary, and the present disclosure is not limited to the configuration of embodiments.

### First Embodiment

### (System Configuration)

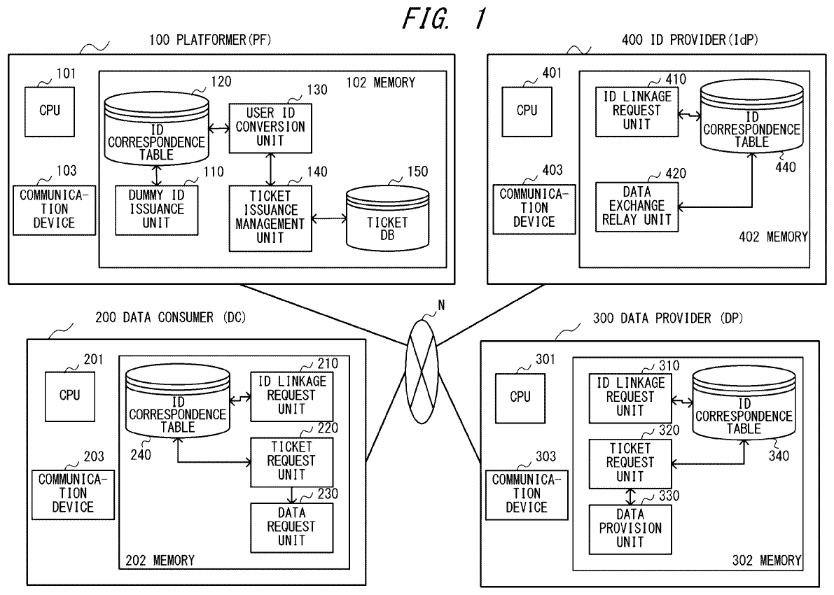

FIG. 1 is a diagram illustrating a configuration of a data exchange system according to one embodiment. The data exchange system is configured so that a platformer (PF) 100, a data consumer (DC) 200, a data provider (DP) 300, and an ID provider (IdP) 400 are communicatively connected to each other via a network N.

The PF 100 is a computer (information processing apparatus) including a CPU 101, a memory 102, and a communication device 103. A program executable by the CPU 101 is stored in the memory 102. When the CPU 101 executes the program, the PF 100 functions as a dummy ID issuance unit 110, an ID correspondence table storage unit 120, a user ID conversion unit 130, a ticket issuance management unit 140, and a ticket DB 150.

The DC 200 is a computer (information processing apparatus) including a CPU 201, a memory 202, and a communication device 203. A program executable by the CPU 201 is stored in the memory 202. When the CPU 201 executes the program, the DC 200 functions as an ID linkage request unit 210, a ticket request unit 220, a data request unit 230, and an ID correspondence table storage unit 240.

The DP 300 is a computer (information processing apparatus) including a CPU 301, a memory 302, and a communication device 303. A program executable by the CPU 301 is stored in the memory 302. When the CPU 301 executes the program, the DP 300 functions as an ID linkage request unit 310, a ticket request unit 320, a data provision unit 330, and an ID correspondence table storage unit 340.

The IdP 400 is a computer (information processing apparatus) including a CPU 401, a memory 402, and a communication device 403. A program executable by the CPU 401 is stored in the memory 402. When the CPU 401 executes the program, the IdP 400 functions as an ID linkage request unit 410, an data exchange relay unit 420, and an ID correspondence table storage unit 440.

Details of each of the above functions will be described in detail later, referring to other drawings. Note that some or all of the functions described above may be realized by a dedicated circuit or device.

The network N is a network configured by a wired communication network and/or a wireless communication network, wherein the communication device 103, the communication device 203, the communication device 303, and the communication device 403 can communicate with each other via the network N.

### (ID Correspondence Table)

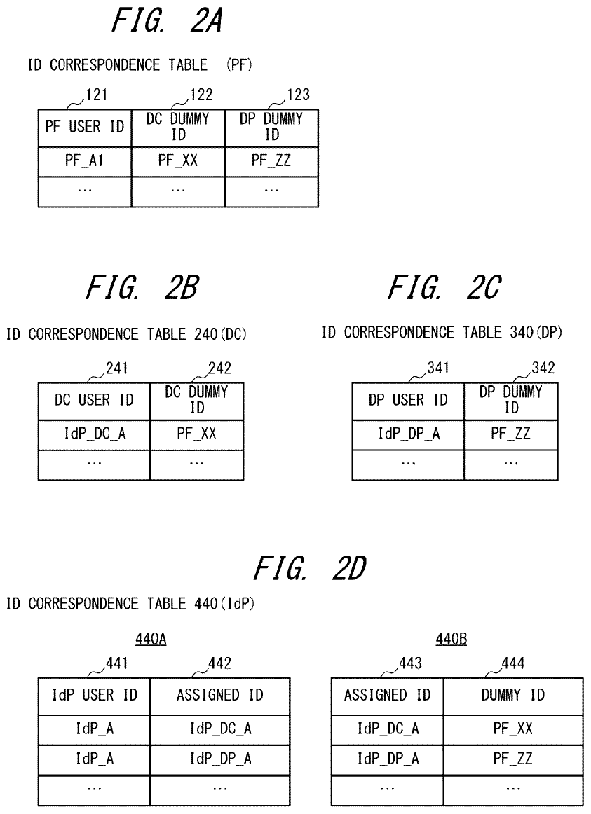

FIG. 2A to FIG. 2D are diagrams illustrating an example of an ID correspondence table held by the PF 100, the DC 200, the DP 300, and the IdP 400, respectively. Here, the DC 200 and the DP 300 are RP, and the DC 200 and the DP 300 do not own the user's account information, but use a unique identifier (e.g., Subject ID) issued by the IdP 400 after the user receives authentication in the IdP 400 as the ID of the user. Here, it is assumed that the user has an account called IdP A in the IdP 400, and the unique identifier issued by the IdP 400 to the DC 200 is IdP_DC_A, and the unique identifier issued by the IdP 400 to the DP 300 is IdP_DP_A. In addition, it is assumed that the user ID named PF_A1 is assigned to this user and managed in the PF 100. In the following, user IDs used by the PF 100, DC 200, and DP 300 will be referred to as PF user ID, DC user ID, and DP user ID, respectively.

FIG. 2A, the PF 100 issues a DC dummy ID 122 and a DP dummy ID 123 for one PF user ID 121, and manages them in association. Therefore, the user ID conversion unit 130 can mutually convert a PF user ID (third identifier), a DC dummy ID (first identifier), and a DP dummy ID (second identifier) by referring to the ID correspondence table 120.

FIG. 2B, the DC 200 manages a DC user ID 241 in association with a DC dummy ID 242 issued by the PF 100 for the user. Therefore, the DC 200 can convert a DC user ID and a DC dummy ID (first identifier) to each other. Note that the DC user ID uses a unique identifier that is issued by the IdP 400.

FIG. 2C, the DP 300 manages a DP user ID 341 in association with a DP dummy ID 342 issued by the PF 100 to the user. Therefore, the DP 300 is capable of converting a DP user ID and a DP dummy ID (second identifier) into each other. Note that the DP user ID uses a unique identifier that is issued by the IdP400.

FIG. 2D, the ID corresponding table 440 of the IdP 400 may include two tables 440A, 440B, but in the first embodiment, only the table 440A is required. The table 440A manages an IdP user ID 441 in association with a unique identifier (referred to as an assigned ID) 442 to be issued to the RP (the DC 200 and the DP 300).

In the examples indicated in FIG. 2A to FIG. 2D, specifically, the PF 100 issues a dummy ID of PF_XX for the DC 200 and a dummy ID of PF_ZZ for the DP 300 to the user named PF_A1 and stores them in association. The DC 200 stores a user ID named IdP_DC_A and a DC dummy ID named PF_XX in association. The DP 300 stores a user ID named IdP_DP_A and a DP dummy ID named PF_ZZ in association.

When the PF 100 receives a DC dummy ID from the DC 200, the PF 100 can obtain a DP dummy ID of the user and notify the DP 300. By having such an ID correspondence table in each device, it is possible to identify the user between the DC 200 and the DP 300 via the PF 100 without any of the devices knowing the user ID in other services. Note that the PF 100 may store only the correspondence between a DC dummy ID and a DP dummy ID without using a PF user ID.

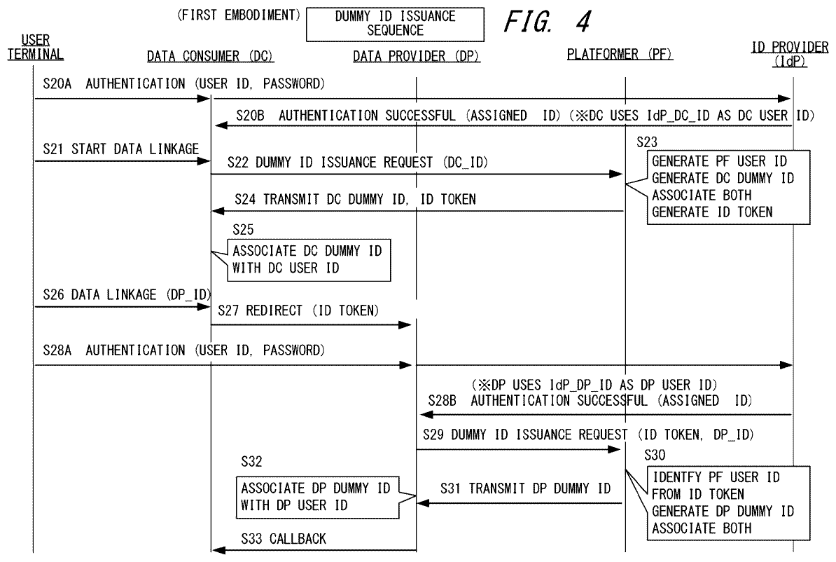

The dummy ID issuance unit 110, the ID linkage request unit 210, and the ID linkage request unit 310 cooperate to issue the dummy ID. The details of this dummy ID issuance process will be described later by referring to FIG. 4.

### (Data Exchange Process)

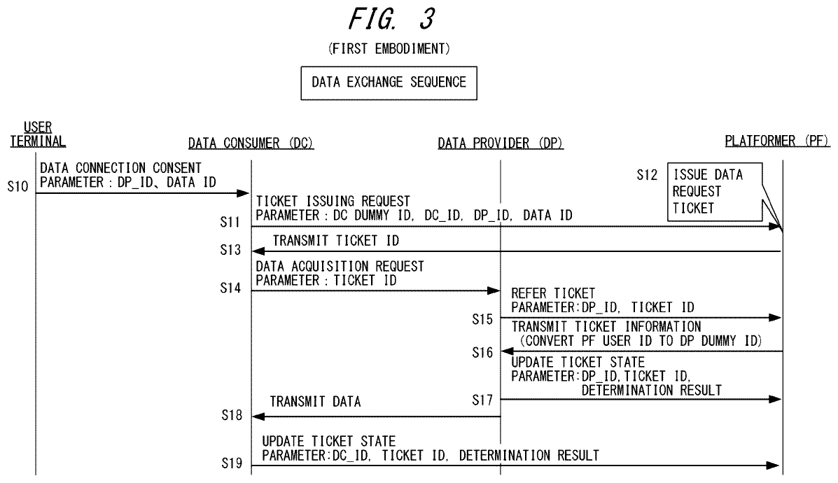

FIG. 3 is a sequence diagram illustrating a flow of exchange process of user data between the DC 200 and the DP 300 via the PF 100. Here, it is assumed that the issuance process of the dummy ID is completed, and PF 100, DC 200, and DP 300 hold the ID correspondence tables indicated in FIGS. 2A to 2C, respectively. Further, it is assumed that the user has completed the authentication process in the DC 200, and that the DC 200 knows that the user ID of the user is DC_A.

In step S10, the user accesses the DC 200 using a user terminal, and requests that the DC 200 acquire some kind of user data from the DP 300. Here, an identifier (DP_ID) of the DP 300 that provides data and an identifier (data ID) that identifies user data to be requested are given to the DC 200 by the user terminal.

In step S11, the ticket request unit 220 of the DC 200 requests the PF 100 to issue a data request ticket for use in user data exchange between the DC 200 and the DP 300. Here, the ticket issuing request includes a DC dummy ID, an identifier (DC_ID) of the DC 200, an identifier (DP_ID) of the DP 300 of a data request destination, and a data ID. The DC dummy ID is obtained by the ticket request unit 220 referring to the ID correspondence table storage unit 240 and acquiring a dummy ID corresponding to the DC user ID. Here, the dummy ID “PF_XX” corresponding to the DC user ID “IdP_DC_A” is obtained. In addition, IdP_DC_ID is known because the DC 200 is issued by the IdP 400, and DP_ID and data ID are notified by the user terminal.

In step S12, in response to receiving the ticket issuance request, the ticket issuance management unit 140 of the PF 100 issues a data request ticket and stores information of the ticket in the ticket DB 150. The data request ticket includes a ticket ID, PF user ID, DC_ID of the data request source, DP_ID of the data request destination, a data ID that identifies the requested data, and a status of the ticket. Here, the user ID conversion unit 130 may obtain the PF user ID from the DC dummy ID notified by the DC 200 and the ID correspondence table 120. Here, the PF user ID “PF_A1” corresponding to the DC dummy ID “PF_XX” is obtained.

In step S13, the ticket issuance management unit 140 of the PF 100 transmits the ticket ID of the issued data request ticket to the DC 200.

In step S14, the data request unit 230 of the DC 200 transmits a data acquisition request to the DP 300. Specifically, the data request unit 230 transmits the data acquisition request including the ticket ID transmitted by the PF 100 to the DP 300 in step S13.

In step S15, the ticket request unit 320 of the DP 300 sends the DP_ID and the ticket ID to the PF 100 to request details of the data request ticket.

In step S16, the ticket issuance management unit 140 of the PF 100 acquires the detailed information of the data request ticket corresponding to the received ticket ID from the ticket DB 150 and transmits it to the DP 300. In this case, the ticket issuance management unit 140 replaces the PF user ID contained in the data request ticket with a DP dummy ID using the user ID conversion unit 130, and transmits the detailed information of the data request ticket. Specifically, the PF user ID “PF_A1” is replaced by the DP dummy ID “PF_ZZ”. Ultimately, the ticket issuance management unit 140 transmits the data ID contained in the requested ticket and the DP dummy ID corresponding to the PF user ID to the DP 300. Here, the ticket issuance management unit 140 transitions the ticket state when the ticket is referenced by the DP 300.

In step S17, the data provision unit 330 of the DP 300 determines whether the requested user data can be provided to the DC 200 by referring to the detailed information of the data request ticket. The determination result is either providable or impossible, that is, accept or reject the data request ticket. The data provision unit 330 transmits the determination result to the PF 100. The ticket issuance management unit 140 of the PF 100 transitions the ticket state in response to acceptance or rejection of the ticket by the DP 300.

After step S18, it is executed when the ticket is accepted by the DP 300. In step S18, the data provision unit 330 of the DP 300 transmits the user data indicated by the data request ticket to the DC 200. Although the user is indicated in the data request ticket by a DP dummy ID, the DP 300 can obtain the corresponding DP user ID by referring to the ID correspondence table 340, and it is possible to specify which user's user data is requested. Specifically, it is possible to identify that the DP dummy ID “PF_ZZ” is the DP user ID “IdP_DP_A”.

In step S19, when the data request unit 230 of the DC 200 receives the user data from the DP 300, it determination whether to accept or reject the user data, and transmits the determination result to the PF 100. The ticket issuance management unit 140 of the PF 100 transitions the ticket state in response to acceptance or rejection of the user data by the DC 200. In case the DC 200 receives the user data, the DC 200 executes processing using the user data. What kind of process is executed is not particularly limited in the present disclosure.

With the above processing, the user data can be exchanged without the DC 200 knowing the user ID in the DP 300 and without the DP 300 knowing the user ID in the DC 200. In addition, the PF 100 can mediate data exchange without retaining the user data itself or retaining the user ID in the DC 200 and DP 300. For these reasons, secure data exchange is realized.

### (Dummy ID Issuance Process)

Referring to FIG. 4, the dummy ID issuance process is described. As described above, the DC 200 and the DP 300 do not hold the user's account information, but use the identifier (assigned ID) issued after the user receives authentication in the IdP 400 as the DC user ID and the DP user ID. In addition, the dummy ID issuance process described below, that is, the association process between the unique user ID and the dummy ID in the PF 100, the DC 200, and the DP 300, is only a specific example, and may be performed by any other method.

In step S20A, the user is authenticated by the DC 200 using the user terminal. Since DC 200 relies on the IdP 400 for user authentication as RP, the user authentication request is transferred to the IdP 400. In step S20B, when the user is authenticated by the IdP 400, the IdP 400 notifies the DC 200 that the authentication has been successful and the assigned ID (IdP_DC_ID). The DC 200 is used as the DC user ID of the ID (IdP_DC_ID) user issued by the IdP 400. In step S21, when the start of data linkage process is requested from the user terminal to the DC 200, in step S22, the ID linkage request unit 210 of the DC 200 requests the PF 100 to issue a dummy ID. Here, the information transmitted from the DC 200 to the PF 100 is a DC identifier, and the DC user ID is not transmitted. This dummy ID is a DC dummy ID (first identifier), and a dummy ID issuance request corresponds to a first identifier issuance request.

In step S23, the dummy ID issuance unit 110 of the PF 100 generates a new PF user ID (third identifier) and a DC dummy ID (first identifier) in response to the dummy ID issuance request from the DC 200, and stores these in the ID correspondence table 120 in association. The dummy ID issuance unit 110 also issues a new ID token and manages it in association with the PF user ID and the DC dummy ID. In step S24, the dummy ID issuance unit 110 transmits the issued DC dummy ID and ID token to DC 200. In step S25, the ID linkage request unit 210 of the DC 200 stores the received DC dummy ID in the ID correspondence table 240 in association with the DC user ID. Note that the DC user ID here is the ID (IdP_DC_ID) issued by the IdP 400.

In step S26, the user terminal transmits a data linkage request including the identifier of the DP 300 of the data linkage destination to the DC 200. In step S27, the DC 200 redirects to the DP 300 while passing the ID token received in step S24. In step S28A, the user is authenticated by the DP 300 using the user terminal. Since the DP 300 relies on the IdP 400 for user authentication as RP, the user authentication request is forwarded to the IdP 400. In step S28B, when the user is authenticated by the IdP 400, the IdP 400 notifies the DP 300 that the authentication has been successful and an assigned ID (IdP_DP_ID). The DP 300 uses the ID (IdP_DP_ID) issued by the IdP 400 as the DP user ID of the user.

In step S29, the ID linkage request unit 310 of the DP 300 requests the PF 100 to issue a dummy ID. Here, the DP identifier and the ID token are transmitted to the PF 100 from the DP 300, and the DP user ID is not transmitted.

In step S30, in response to the dummy ID issuance request from the DP 200, the dummy ID issuance unit 110 of the PF 100 issues a new DP dummy ID and stores it in the ID correspondence table 120 in association with the PF user ID and the DC dummy ID. Note that the dummy ID issuance unit 110 can grasp which PF user IDs and DC dummy IDs are requested to issue DP dummy IDs from the received ID token. In step S31, the dummy ID issuance unit 110 transmits the issued DP dummy ID to DP 300. In step S32, the ID linkage request unit 310 of the DP 300 stores the received DP dummy ID in association with the DP user ID in the ID correspondence table 340. In step S33, the DP 300 calls back to the DC 200, and control of the user terminal returns to the DC 200.

As described above, issuance and sharing of the dummy IDs for each of the user IDs of the PF 100, the DC 200, and the DP 300 as indicated in FIG. 2A to FIG. 2C is completed. In this case, PF user ID, DC user ID, and DP user ID are not notified to other devices, so that the association of accounts can be prevented.

In the above description, both the DC 200 and the DP 300 rely on the IdP 400 for user authentication as RP, but either of the DC 200 and the DP 300 may own the user's account information. In this case, the DC 200 or the DP 300, which does not function as an RP, uses a user ID managed by itself in place of the ID (IdP_DC_ID or IdP_DP_ID) issued by the IdP 400.

In other embodiments, the PF 100 may generate the DC dummy ID and the DP dummy ID as a ciphertext in which the PF user ID is encrypted using a cryptographic key for the DC 200 and the DP 300. For example, the dummy ID issuance unit 110 may generate a new PF user ID in response to a new dummy ID issuance request from the DC, and generate the DC dummy ID (first identifier) by performing an encryption process (conversion process) on the PF user ID by using the encryption key for the DC. Auxiliary, the dummy ID issuance unit 110 may generate the user ID (second identifier) for DP by performing an encryption process (conversion process) using the encryption key for DP on the PF user ID specified by the ID token in response to the dummy ID issuance request from the DP. Further, the user ID conversion unit 130 can obtain a DP user ID corresponding to the DC user ID by performing encryption processing (conversion process) using the DP encryption key after performing decoding process (reverse conversion process) using the DC encryption key on the DC user ID. The similar applies to the conversion of user ID for DP to user ID for DC. Therefore, the PF 100 can convert the DC dummy ID, the DP dummy ID, and the PF user ID to each other without retaining the DC dummy ID and the DP dummy ID. Under the premise that the encryption key is kept secret, this embodiment can prevent the leakage of the corresponding tables of PF user ID, DC user ID, and DP user ID.

Auxiliary, the dummy ID issuance unit 110 may use the user ID (third identifier) itself as the DC dummy ID (first identifier) and the DP dummy ID (second identifier). In this example, there is a disadvantage that direct data exchange is possible by omitting PF intermediation by colluding between DC and DP, but secure data exchange between DC and DP is possible.

### Advantageous Effects of the Present Embodiment

The user data can be exchanged without the DC 200 knowing the user ID in the DP 300, and without the DP 300 knowing the user ID in the DC 200. In addition, the PF 100 can mediate data exchange without retaining the user data itself or retaining the user ID in the DC 200 and the DP 300. For these reasons, secure data exchange is realized. In addition, it will be possible to charge and handle errors based on the status management of data request tickets.

### Modification of the First Embodiment

An impersonation attack is considered in which a malicious attacker provides false data providers and provides data from false data providers to the data consumers. Similarly, spoofing attacks could occur when a malicious attacker provides false data consumers and takes data from the data provider.

In order to prevent such attacks, when the PF 100 is requested to perform ID linkage operations by the RP (the DC 200 and the DP 300), the client authentication, that is, verification that the RP is a client trusted by the PF 100, may be performed. In order to achieve client authentication, it is necessary for the RP to register information with the PF 100 to have them authenticate themselves. However, when the RP has already registered authentication information for the IdP, it may be troublesome for both the RP and the PF to register separate authentication information.

In order to eliminate such trouble, when the IdP registers its own authentication information in the PF 100 and the RP (DC and/or DP) performs an ID linkage operation on the PF 100 (sending a dummy ID issuance request), the dummy ID issuance request includes the authentication information registered in the IdP and is sent to the PF 100. The PF 100 can verify the reliability of the RP by making an inquiry request to the authenticated IdP for the RP authentication information, and when authentication is successful, the dummy ID (DC dummy ID and DP dummy ID) is sent to the RP. In this way, a trust chain can be constructed in which the PF trusts the RP, the IdP trusts the RP, and thus the PF trusts the RP.

The signature on the client certificate and the client secret can be used as the authentication information registered in the IdP.

### Second Embodiment

In the first embodiment, the DC 200 and the DP 300 perform ID linkage process (dummy ID issuance request to PF 100 and conversion of dummy ID and user ID), but in this embodiment, the IdP 400 executes the ID linkage process. In the following, it is assumed that the IdP used by the DC 200 and the IdP used by the DP 300 are different entities, and the former is referred to as IdP-A, and the latter is referred to as IdP-B. IdP-A corresponds to a first ID provider, and IdP-B corresponds to a second ID provider.

In this embodiment, since the ID linkage process is performed by the IdP 400, the ID correspondence table 440 of the IdP 400 includes a table 440B that is managed by associating the assigned ID 443 and the dummy ID 444. In the example of FIG. 2D, both the assigned ID for DC and the assigned ID for DP are associated with dummy IDs in table 440B, but in reality, each of IdP-A and IdP-B has one of these records.

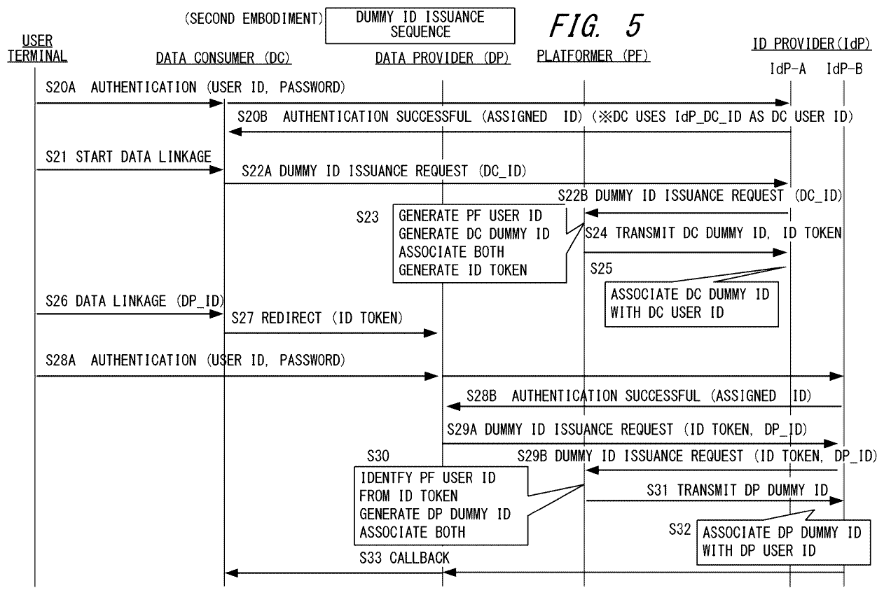

Referring FIG. 5, a dummy ID issuance sequence according to the present embodiment will be described. Explanation of the processing the same as that of embodiment 1 (FIG. 4) is omitted by attaching the same number.

The processing of steps S20A to S20B is the similar processing as the first embodiment.

When the data linkage process is started in step S21, the DC 200 requests the PF 100 to issue a DC dummy ID via the IdP-A. Specifically, in step S22A, the ID linkage request unit 210 of the DC 200 requests the IdP-A to issue a dummy ID, and in step S22B, the ID linkage request unit 410 of the IdP-A sends the dummy ID issuance request to the PF 100.

In step S23, the dummy ID issuance unit 110 of the PF 100 generates a new PF user ID and a DC dummy ID in response to receiving the dummy ID issuance request, and stores these in association with the ID correspondence table 120. The dummy ID issuance unit 110 also issues a new ID token and manages it in association with the PF user ID and the DC dummy. In step S24, the dummy ID issuance unit 110 transmits the issued DC dummy ID and ID token to the IdP-A. In step S25, the ID linkage request unit 410 of the IdP-A stores the received DC dummy ID in the ID correspondence table 440B in association with the DC user ID.

The processing of steps S26 to S28B in the same manner as the first embodiment.

When the authentication on the DP 300 is successful and the data linkage process starts, the DP 300 requests the PF 100 to issue a DP dummy ID via the IdP-B. Specifically, in step S29A, the ID linkage request unit 310 of the DP 300 requests the IdP 400 to issue a dummy ID, and in step S29B, the ID linkage request unit 410 of the IdP 400 sends the dummy ID issuance request to the PF 100. The dummy ID issuance request includes the ID token and DP identifier.

In step S30, in response to the dummy ID issuance unit 110 of the PF 100 issues a new DP dummy ID in response to the dummy ID issuance request from the IdP-B, and stores it in the ID correspondence table 120 in association with the PF user ID and the DP dummy ID. Note that the dummy ID issuance unit 110 can grasp which PF user IDs and DC dummy IDs are requested to issue DP dummy IDs from the received ID token.

In step S31, the dummy ID issuance unit 110 transmits the issued DP dummy ID to the IdP-B. In step S32, the ID linkage request unit 410 of the IdP-B stores the received DP dummy ID in the ID correspondence table 440B in association with the DP user ID. In step S33, the DP 300 calls back to the DC 200, and control of the user terminal returns to the DC 200.

Note that, in this example, although both the DC 200 and the DP 300 have entrusted ID linkage process to the IdP 400, either one of the DC 200 and the DP 300 may perform ID linkage process itself in the same manner as the first embodiment, and store correspondence between dummy IDs and DC user IDs or DP user IDs in the ID correspondence table.

According to the embodiment, there may be no need for the DC 200 or the DP 300 to implement the ID linkage function, and only the IdP 400 may implement the ID linkage function. Therefore, it becomes easier to provide new DC 200 and DP 300.

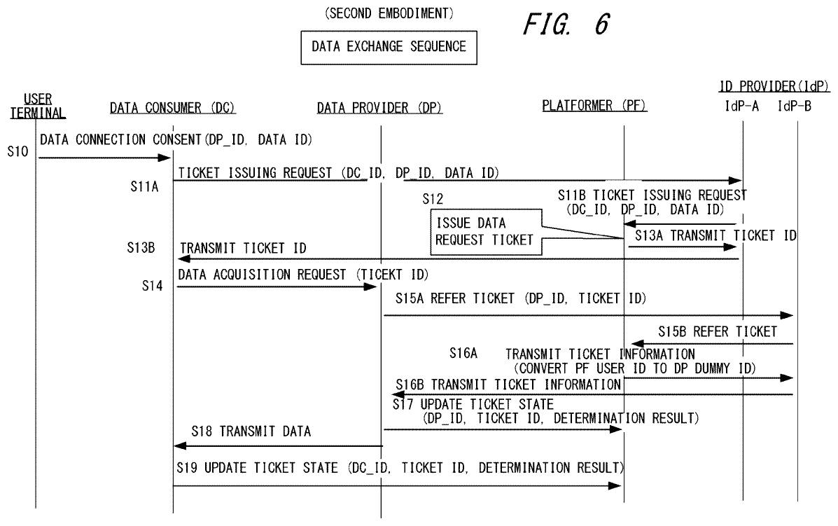

Referring FIG. 6, a data exchange process in the present embodiment will be described. Explanation of the processing the same as that of embodiment 1 (FIG. 3) will be omitted by attaching the same number.

In step S10, when the user data connection consent acquired, in step S11A, the ticket request unit 220 of the DC 200 requests the IdP-A to issue a data request ticket for use in exchanging user data between the DC 200 and the DP 300. The ticket issuing request includes the identifier (DC_ID) of the DC 200, the identifier (DP_ID) of the DP 300 to which the data is requested, and the data ID. In step S11B, the data exchange relay unit 420 of the IdP-A requests the PF 100 to issue the data request ticket. In this case, the IdP-A includes the DC dummy ID in the ticket issuance request. Since the IdP-A grasps which user the ticket issuance request is from, it is possible to grasp the DC dummy ID of the user by referring to the ID correspondence table 440B. The DC dummy ID is obtained by acquiring a dummy ID corresponding to the DC user ID with reference to the ID correspondence table storage unit 440. Here, the dummy ID “PF_XX” corresponding to the DC user ID “IdP_DC_A” is obtained.

Although the issuance process of the data request ticket by the PF 100 in step S12 are the same as the first embodiment, the PF 100 transmits the ticket ID to the DC 200 via the IdP-A (steps S13A and S13B). Note that the PF 100 may directly transmit the ticket ID to the DC 200 without intervening through the IdP-A.

In step S14, the data request unit 230 of the DC 200 transmits a data acquisition request to the DP 300. Specifically, the data request unit 230 transmits to the DP 300 as a data acquisition request including the ticket ID transmitted by the PF 100 in step S13.

The ticket request unit 320 of the DP 300 transmits the ticket reference request including the ticket ID contained in the data acquisition request to the PF 100. Specifically, in step S15A, the ticket request unit 320 of the DP 300 transmits the DP_ID and the ticket ID to the IdP-B to request details of the data request ticket. In step S15B, the IdP-B sends the DP_ID and the ticket ID to the PF 100 to request details of the data request ticket. Here, the DP 300 is sending the ticket reference request to the PF 100 via the IdP-B, but may send it directly to the PF 100 without via the IdP-B.

In step S16, the ticket issuance management unit 140 of the PF 100 acquires the detailed information of the data request ticket corresponding to the received ticket ID from the ticket DB 150 and transmits it to the DP 300 via the IdP-B (steps S16A and S16B). In this case, the ticket issuance management unit 140 replaces the PF user ID contained in the data request ticket with a DP dummy ID using the user ID conversion unit 130, and transmits the detailed information of the data request ticket. Specifically, the PF user ID “PF_A1” is replaced by the DP dummy ID “PF_ZZ”. Here, the ticket issuance management unit 140 transitions the ticket state when the ticket is referenced by the DP 300. Note that the PF 100 may transmit the detailed information of the ticket to the DP 300 without via the IdP-B.

The process after step 17 is the same as the first embodiment.

### Modification of the Second Embodiment

It is assumed that the DC 200 and the DP 300, which attempt to link IDs, are RPs of the same IdP. In that case, it is not possible to prevent the aggregation of names. Because both the DC 200 and the DP 300 depend on the same IdP to perform the ID linkage operation of the specific user, this IdP can grasp that the specific user is using DC and DP.

In order to prevent such aggregation of names, the following measures are performed. In step S23, when issuing a DC dummy ID of a certain user according to a request from the IdP, if the PF 100 has already issued a DP dummy ID for the same IdP for the same user, the DC dummy ID is not issued. Further, in step S29, when issuing the DP dummy ID of a certain user according to the request from the IdP, when the PF 100 has already issued the DC dummy ID for the same IdP for the same user, it does not issue the DP dummy ID. That is, when the IdP-A and the IdP-B are the same entity, the PF 100 does not issue the DC dummy ID or the DP dummy ID even if it receives the DC dummy ID issuance request or the DP dummy ID issuance request.

Preventing the issuance of a DC dummy ID and DP dummy ID of a certain user for the same IdP in this way makes it possible to prevent the aggregation of names.

### Other Embodiment

The above embodiments are an example only, and the present disclosure can be implemented with appropriate modifications within a certain range that does not deviate from the abstract.

### OTHER EMBODIMENTS

The embodiments described above are examples, and the present disclosure may be changed and carried out as appropriate without departing from the gist of the present disclosure.

The present disclosure may also be implemented by supplying a computer program for implementing a function described in the embodiment above to a computer, and by reading and executing the program by at least one processor of the computer. Such a computer program may be provided to a computer by a non-transitory computer-readable storage medium which is connectable to a system bus of a computer, or may be provided to a computer through a network. The non-transitory computer-readable storage medium may be any type of disk such as a magnetic disk (floppy (registered trademark) disk, a hard disk drive (HDD), etc.), an optical disk (CD-ROM, DVD disk, Blu-ray disk, etc.), a read only memory (ROM), a random access memory (RAM), an EPROM, an EEPROM, a magnetic card, a flash memory, an optical card, and any type of medium which is suitable for storing electronic instructions.

What is claimed is:

1. A user data exchange system comprising a data consumer, a data provider, and a platformer, and intermediating exchange of user data between the data consumer and the data provider, wherein
the data consumer transmits a first identifier issuance request to the platformer to request issuance of a user identifier,
the platformer, in response to receiving the first identifier issuance request, generates a first identifier, transmits the first identifier to the data consumer, and stores the first identifier in association with a third identifier for identifying the user,
the data consumer stores the first identifier in association with a first user ID,
the data provider transmits a second identifier issuance request to the platformer to request issuance of a user identifier,
the platformer, in response to receiving the second identifier issuance request, generates a second identifier, transmits the second identifier to the data provider, and stores the second identifier in association with the third identifier,
the data provider stores the second identifier in association with a second user ID,
the data consumer transmits, to the platformer, a ticket issuance request including information identifying user data to be requested, the first identifier corresponding to the first user ID, and information identifying the data provider as a destination of a request for the user data,
the platformer, in response to receiving the ticket issuance request, generates a data request ticket including a ticket identifier, the third identifier corresponding to the first identifier, the information identifying the user data, and the information identifying the data provider as the destination of a request for the user data, and transmits the ticket identifier to the data consumer,
the data consumer transmits a data acquisition request including the ticket identifier to the data provider,
the data provider transmits a ticket reference request including the ticket identifier included in the data acquisition request to the platformer,
the platformer identifies the data request ticket corresponding to the ticket identifier included in the ticket reference request, and transmits the information identifying the user data and the second identifier corresponding to the third identifier to the data provider,
the data provider transmits the user data to be requested and relating to a user identified by the second user ID corresponding to the second identifier to the data consumer, and
at least one of the data consumer or the data provider uses, as the first user ID or the second user ID, an identifier issued after the user has been authenticated by an ID provider, without retaining account information of the user.

2. The user data exchange system according to claim 1, wherein
the ID provider has registered authentication information with the platformer,
the data consumer transmits, to the platformer, the first identifier issuance request by including the authentication information registered with the ID provider,
the platformer transmits the first identifier to the data consumer when authentication of the authentication information included in the first identifier issuance request is successful,
the data provider transmits, to the platformer, the second identifier issuance request by including the authentication information registered with the ID provider, and
the platformer transmits the second identifier to the data provider when authentication of the authentication information included in the second identifier issuance request is successful.

3. A user data exchange system comprising a data consumer, a data provider, a platformer, a first ID provider, and a second ID provider, and intermediating the exchange of user data between the data consumer and the data provider, wherein
the first ID provider stores a first user ID of the user,
the second ID provider stores a second user ID of the user,
the data consumer transmits a first identifier issuance request to request issuance of a user identifier to the platformer via the first ID provider,
the platformer, in response to receiving the first identifier issuance request, generates a first identifier, transmits the first identifier to the first ID provider, and stores the first identifier in association with a third identifier identifying the user,
the first ID provider stores the first identifier in association with the first user ID,
the data provider transmits a second identifier issuance request to request issuance of a user identifier to the platformer via the second ID provider,
the platformer, in response to receiving the second identifier issuance request, generates a second identifier, transmits the second identifier to the second ID provider, and stores the second identifier in association with the third identifier,
the second ID provider stores the second identifier in association with the second user ID,
the data consumer transmits, to the first ID provider, a first ticket issuance request including information identifying user data to be requested and information identifying the data provider as a destination of a request for the data user,
the first ID provider, in response to receiving the first ticket issuance request, transmits a second ticket issuance request including the information identifying the user data to be requested, the first identifier, and the information identifying the data provider as the destination of the request of the user data to the platformer,
the platformer, in response to receiving the second ticket issuance request, generates a data request ticket including a ticket identifier, the third identifier corresponding to the first identifier, the information identifying the user data, and the information identifying the data provider as the destination, and transmits the ticket identifier to the data consumer via the first ID provider,
the data consumer transmits a data acquisition request including the ticket identifier to the data provider,
the data provider transmits a ticket reference request including the ticket identifier included in the data acquisition request to the platformer via the second ID provider or directly,
the platformer, in response to receiving the ticket reference request, identifies the data request ticket corresponding to the ticket identifier included in the ticket reference request, and transmits the information identifying the user data and the second identifier corresponding to the third identifier to the data provider via the second ID provider or directly,
the data provider transmits the user data to be requested and related to the user identified by the second user ID corresponding to the second identifier to the data consumer.

4. The user data exchange system according to claim 3, wherein,
when the first ID provider and the second ID provider are the same entity, the platformer does not issue the first identifier or the second identifier even if receiving the first identifier issuance request or the second identifier issuance request.
